(19) United States
(12) Patent Application Publication
(10) Pub. No.: US 2026/0234452 A1
(43) Pub. Date: Aug. 13, 2026

(54) Two Component Solvent Based Laminating Adhesive for Medical Cold Forming Packages

(71) Applicant: ARKEMA FRANCE, Puteaux (FR)

(72) Inventors: Rui Shi, Shanghai (CN); Xinhong Wang, Shanghai (CN); Weifang Zhang, Shanghai (CN)

(73) Assignee: ARKEMA FRANCE, Puteaux (FR)

(21) Appl. No.: 19/156,491

(22) PCT Filed: Feb. 15, 2023
(86) PCT No.: PCT/CN2023/076268

§ 371 Date: Aug. 14, 2025

(51) Int. Cl. C09J 175/06; C08G 18/38; C08G 18/40; C08G 18/42; C08G 18/58; C08G 18/66; C09J 11/08

(52) U.S. Cl. CPC C09J 175/06; C08G 18/3885; C08G 18/4045; C08G 18/42; C08G 18/58; C08G 18/6633; C09J 11/08

(57) ABSTRACT

A two component solvent based laminating adhesive comprising an isocyanate and a polyol component where the isocyanate component is comprised of: (1) an isocyanate monomer, a polyisocyanate, an isocyanate prepolymer, or mixture of these; and (2) ethyl acetate is disclosed. The polyol component is comprised of (1) a polyester polyol with a molecular weight greater than or equal to 8000 and a T_{g} less than 5° C., and (2) a phosphate ester polyol of structure [1] where R′ is selected from any organic group, and (3) an epoxy resin.

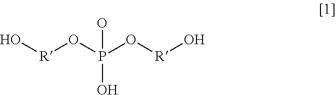

### FIELD

The current disclosure relates to solvent based laminating adhesives. More specifically the current disclosure relates to solvent based laminating adhesives for medical cold forming packages. The current disclosure also relates to laminates formed using the disclosed solvent based laminating adhesive.

### BACKGROUND

Adhesive compositions are useful for a wide variety of purposes. For instance, some adhesives are used to adhere two or more film layers of substrates together thereby forming composite films, i.e., laminates comprising the two or more film layers. Example of substrates typically include polyethylenes, polypropylenes, polyesters, polyamides, metals, papers, or cellophane and the like. The use of adhesives in different laminating end-use applications is generally known. For example, adhesives, generally applied between laminating films, can be used in the manufacture of film/film and film/foil laminates used in the flexible packaging industry for packaging of foodstuffs, pharmaceuticals, and industrial consumables, especially for food packaging. Laminating adhesives can be classified generally into three categories: (1) solvent-based laminating adhesives, (2) solventless laminating adhesives, and (3) water-based laminating adhesives. The performance of an adhesive varies by category and by the application in which the adhesive is applied.

Within the category of solvent-based laminating adhesives, there are many varieties. One variety includes multi-component laminating adhesives. Typically, a two-component solvent based laminating adhesive includes a first component comprising an isocyanate and a second component comprising one or more polyols. Common solvents used in such systems include methyl ethyl ketone, ethyl acetate, toluene, and the like.

The two components (i.e., the isocyanate and polyol components) of the adhesive composition are combined in a predetermined ratio, thereby forming an adhesive composition. The adhesive composition, carried in a solvent, is then applied on a film/or foil substrate. The solvent is evaporated from the applied adhesive composition. Another film/or foil substrate is then brought into contact with the other substrate, forming a curable laminate structure. The laminate structure is cured to bond the two substrates together.

Medical cold forming packages usually contain a foil layer, an adhesive layer and a PVC layer. Bond strength and deep draw depth are key performance parameters in this application. The readily oxidizable substance content in medical cold forming packages is subject to strict government regulation. There exists a continuing need for adhesives with low readily oxidizable substance content but good bond strength and deep draw depth.

### SUMMARY OF DISCLOSURE

Currently disclosed is a two component solvent based laminating adhesive comprising an isocyanate and a polyol component. The isocyanate component is comprised of: (1) an isocyanate monomer, a polyisocyanate, an isocyanate prepolymer, or mixtures of these; and (2) ethyl acetate. The polyol component is comprised of (1) a polyester polyol with a molecular weight greater than or equal to 8000 and a T_{g} less than 5° C., (2) a phosphate ester polyol of structure 1 where R′ is selected from any organic group, and (3) an epoxy resin.

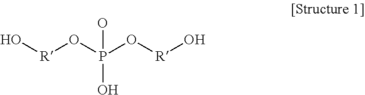

The epoxy resin comprises 14 to 30 dry wt. % based on the weight of the polyol component. The ratio of the isocyanate component to the polyol component is 1 to 21 dry wt. % based on the weight of the solvent based laminating adhesive. The total phosphate ester content is 0.3 to 2 dry wt. % based on the weight of the solvent based laminating adhesive. A laminate formed from the disclosed solvent based laminating adhesive is also disclosed.

### DETAILED DESCRIPTION

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1 to 7 above includes subranges 1 to 2; 2 to 6; 5 to 7; 3 to 7; 5 to 6; etc.).

The term “composition” refers to a mixture of materials which comprise the composition, as well as reaction products and decomposition products formed from the materials of the composition.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

An “isocyanate” is a chemical that contains at least one isocyanate group in its structure. An isocyanate group is represented by the formula: —N═C═O or abbreviated as “NCO”. An isocyanate that contains more than one, or at least two, isocyanate groups is a “polyisocyanate.” An isocyanate that has two isocyanate groups is a diisocyanate and an isocyanate that has three isocyanate groups is a triisocyanate, etc.

A “polyisocyanate” is a molecule that contains at least two isocyanate groups.

A “polyether” is a compound containing two or more ether linkages in the same linear chain of atoms.

A “polyester” is a compound containing two or more ester linkages in the same linear chain of atoms.

A “polyol” is an organic compound containing multiple hydroxyl (OH) groups. In other words, a polyol contains at least two OH groups. Nonlimiting examples of suitable polyols include diols having two OH groups, triols having three OH groups, and tetraols having four OH groups.

A “polyester polyol” is a compound that contains a polyester and a polyol in the backbone structure of the compound.

A “polyether polyol” is a compound that contains a polyether and a polyol in the backbone structure of the compound.

A “film,” including when referring to a “film layer” in a thicker article, unless expressly having the thickness specified, includes any thin, flat extruded or cast thermoplastic article having a generally consistent and uniform thickness of about 0.5 millimeters (mm) (20 mils) or less in one dimension.

A “polymer film” is a film that is made of a polymer or a mixture of polymers. The composition of a polymer film is typically, 80 percent by weight (wt %) of one or more polymers.

A “polymer” is a polymeric compound prepared by polymerizing monomers, whether of the same or a different type. The generic term polymer thus embraces the term “homopolymer” (employed to refer to polymers prepared from only one type of monomer, with the understanding that trace amounts of impurities can be incorporated into the polymer structure), and the term “interpolymer,” which includes copolymers (employed to refer to polymers prepared from two different types of monomers), terpolymers (employed to refer to polymers prepared from three different types of monomers), and polymers prepared from more than three different types of monomers. Trace amounts of impurities, for example, catalyst residues, may be incorporated into and/or within the polymer. It also embraces all forms of copolymer, e.g., random, block, etc. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to as being based on “units” that are the polymerized form of a corresponding monomer.

### Two Component Solvent-Based Laminating Adhesive

A two component solvent-based laminating adhesive comprising an isocyanate component and a polyol component is disclosed. The ratio of the isocyanate component to the polyol component is 1 to 21 dry wt. % based on the weight of the solvent based laminating adhesive. All individual values and ranges between 1 and 21 wt. % are disclosed and included herein. For example, the ratio of the isocyanate component to the polyol component can be 1 to 10 dry wt. %, 1 to 5 wt. %, or 1 to 4 wt. %.

The two component solvent-based laminating adhesive can contain one or more anti-hydrolytic agents such as azopyridine or carbodiimide. The two component solvent-based laminating adhesive can contain an antioxidant. The two component solvent based laminating adhesive of claim 1 can contain no siliane, no polyether polyol, no phenolic epoxy resin, and/or no highly reactive amine initiated polyol.

The two component solvent based laminating adhesive can have a V0, measured as described below, from 0.05 to 1.70. All individual values and ranges are included and disclosed. For example, the two component solvent based laminating adhesive can have a V0 measured as described below, from 0.08 to 0.20 Na₂S₂O₃/ml or from 0.10 to 0.16 Na₂S₂O₃/ml.

The adhesive composition of the present disclosure generally includes at least one solvent. Suitable solvents can include but are not limited to, ethyl acetate, propyl acetate, methyl ether ketone, methyl butyl ketone, acetone, toluene, and mixtures thereof.

The amount of the solvent, used in the present disclosure can be, for example, from 20 wt % to 90 wt %, from 30 wt % to 80 wt %, or from 40 wt % to 70 wt % based on the total amount of the components in the adhesive composition.

The adhesive composition of the present disclosure can include one or more additional optional conventional ingredients or additives including but not limited to, catalysts, tackifiers, adhesion promoters, antioxidants, fillers, colorants, pigments, surfactants, solvents, polymers (including, for example, thermoplastic resins other than those discussed herein above), dehydrating agents (including, for example, silanes), benzoyl chloride, other polyols (including, for example, fatty polyols), ultraviolet indicators, and combinations of two or more of these.

### Isocyanate Component

The isocyanate component of the two component solvent-based laminating adhesive can comprise an isocyanate monomer, an isocyanate prepolymer, a polyisocyanate, or mixtures of two or more of these. The isocyanate monomer, isocyanate prepolymer, or polyisocynate can comprise aliphatic isocyanate, aromatic isocyanate or cyclic isocyanate.

The aromatic-based isocyanates useful in the present disclosure can include, for example, one or more polyisocyanate compounds including, but are not limited to, for example 1,3- and 1,4-phenylene diisocyanate; 1,5-naphthylene diisocyanate; 2,4′-diphenylmethane diisocyanate (2,4′-MDI); 4,4′-diphenylmethane diisocyanate (4,4′-MDI); 3,3′-dimethyl-4,4′-biphenyldiisocyanate (TODI) and isomers thereof; polymeric isocyanates; and mixtures of two or more thereof.

Exemplary of some of the commercial aromatic-based components useful in the present disclosure can include, for example, ISONATE™ 125 M, ADCOTTE™ L76-204, COREACTANT CT™, available from The Dow Chemical Company; DESMODUR™ E 2200/76, available from The Covestro Company; and mixtures thereof.

The aliphatic-based isocyanate in the isocyanate component can be aliphatic polyisocyanates having 3 carbon atoms (C) to 16 C, or 4 C to 12 C in the linear or branched alkylene residue. Also suitable for use in the present disclosure are cycloaliphatic polyisocyanates including, for example, cycloaliphatic polyisocyanates having 4 C to 18 C, or 6 C to 15 C in the cycloalkylene residue.

Examples of suitable aliphatic polyisocyanates and cycloaliphatic polyisocyanates useful in the present disclosure include, but are not limited to, cyclohexane diisocyanate, methylcyclohexane diisocyanate, ethylcyclohexane diisocyanate, propylcyclohexane diisocyanate, methyldiethylcyclohexane diisocyanate, propane diisocyanate, butane diisocyanate, pentane diisocyanate, hexane diisocyanate, heptane diisocyanate, octane diisocyanate, nonane diisocyanate, nonane triisocyanate, such as 4-isocyanatomethyl-1,8-octane diisocyanate (TIN), decane di- and triisocyanate, undecane di- and triisocyanate and dodecane di- and triisocyanate, hexamethylene diisocyanate (HDI), diisocyanatodicyclohexylmethane (H₁₂MDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI), xylylene diisocyanate (XDI), 1,4- or 1,3-bis(isocyanatomethyl)cyclohexane (H₆XDI), tetramethylxylylene diisocyanate, and dimers, trimers, derivatives and mixtures of the of two or more thereof. Suitable aliphatic polyisocyanates and cycloaliphatic polyisocyanates useful in the present disclosure also include, for example, XDI-based polyisocyanate, H₆XDI-based polyisocyanate, XDI isocyanurate, HDI-based polyisocyanate, H₁₂MDI-based polyisocyanate, HDI isocyanurate, and mixtures of two or more thereof.

Exemplary of some of the commercial products of aliphatic-based components useful in the present disclosure include, for example, TAKENATE™ D-110N and TAKENATE™ D-120N, available from Mitsui Chemical; DESMODUR™ N 3200, DESMODUR™ Quix 175, and DESMODUR™ 2460M available from The Coverstro Company; and mixtures thereof.

Additional isocyanate-containing compounds suitable for use according to the present disclosure include, but are not limited to, polyisocyanate of 4-methyl-cyclohexane 1,3-diisocyanate, 2-butyl-2-ethylpentamethylene diisocyanate, 3 (4)-isocyanatomethyl-1-methylcyclohexyl isocyanate, 2-isocyanatopropylcyclohexyl isocyanate, 2,4′-methylenebis(cyclohexyl) diisocyanate, 1,4-diisocyanato-4-methyl-pentane, and mixtures of two or more thereof.

The amount of isocyanate monomer, prepolymer, polyisocyanate, or mixture of these can be above 50 wt. % based on the weight of the isocyanate component. The amount of isocyanate monomer, prepolymer, polyisocyaante or mixture of these can be from 50 to 99 wt. % based on the weight of the isocyanate component. All mixtures and individual values are included and disclosed. For example the amount of isocyanate monomer, prepolymer, polyisocyanate or mixture of these can comprise from an upper limit of 99, 95, 90, 85, 80, 75, 70, 65, 60, or 55 wt. % to a lower limit of 50, 55, 60, 65, 70, 75, 80, 85, 90, 95 wt. % based on the weight of the isocyanate component. The isocyanate component can also comprise ethyl acetate.

### Polyol Component

The polyol component can comprise a polyester polyol with a molecular weight greater than or equal to 8000 and a T_{g} less than 5° C. Suitable polyester polyols useful in the present disclosure include, but are not limited to, for example, aliphatic polyester polyols; aromatic polyester polyols; copolymers of aliphatic and aromatic polyester polyols; polycarbonate polyols; polycaprolactone polyols; and mixtures thereof. These polyester polyols are the reaction products of polybasic acids and polyhydric alcohols; or are the reaction of phosgene or a carbonate monomer with a polyhydric alcohol; or are produced via ring opening polymerization of cyclic ester compounds.

Exemplary of suitable polybasic acids useful in the present disclosure include succinic acid, adipic acid, azelaic acid, sebacic acid, dodecanedicarboxylic acid, maleic anhydride, fumaric acid, 1,3-cyclopentane-dicarboxylic acid, 1,4-cyclohexanedicarboxylic acid, terephthalic acid, isophthalic acid, phthalic acid, 1,4-naphthalenedicarboxylic acid, 2, 5-naphthalenedicarboxylic acid, 2,6-naphthalenedicarboxylic acid, naphthalic acid, biphenyldicarboxylic acid, 1,2-bis(phenoxy) ethane-p,p′-dicarboxylic acid, and anhydrides or ester-forming derivatives of these dicarboxylic acids; and p-hydroxybenzoic acid, p-(2-hydroxyethoxy)benzoic acid, and ester-forming derivatives or dimer acids of these dihydroxycarboxylic acids; and mixtures thereof. These polybasic acids may be used alone or in a combination of two or more polybasic acids.

Any known polyhydric alcohol can be used according to this disclosure. Non-limiting examples of suitable polyhydric alcohols useful in the present disclosure include: glycols such as ethylene glycol, propylene glycol, 1,3-propanediol, 1,4-butanediol, 1,5-pentanediol, 3-methyl-1,5-pentanediol, 1,6-hexanediol, neopentylglycol, methylpentanediol, dimethylbutanediol, butylethylpropanediol, diethylene glycol, triethylene glycol, tetraethylene glycol, dipropylene glycol, tripropylene glycol, bishydroxyethoxybenzene, 1,4-cyclohexanediol, 1,4-cyclohexane-dimethanol, triethylene glycol, polycaprolactone diol, dimer diol, bisphenol A, and hydrogenated bisphenol A; polyesters produced through ring opening polymerization of cyclic ester compounds such as propiolactone, butyrolactone, ε-caprolactone, 8-valerolactone, and β-methyl-δ-valerolactone; and polyethers produced from addition polymerization of one or more monomers including ethylene oxide, propylene oxide, butylene oxide, styrene oxide, epichlorohydrin, tetrahydrofuran, and cyclohexylene in the usual manner with the aid of one or more compounds containing two active hydrogen atoms as an initiator, such as ethylene glycol, diethylene glycol, triethylene glycol, propylene glycol, trimethylene glycol, 1,3-butanediol, 1,4-butanediol, 1,6-hexanediol, and neopentyl glycol; and mixtures thereof. These polyhydric alcohols may be used alone or in a combination of two or more polyhydric alcohols.

The amount of polyester polyol used in the polyol component can be over 50 wt. % based on the weight of the polyol component. The amount of polyester polyol used in the polyol component can be from 50 to 70 wt. % based on the wt. % of the polyol component. All internal individual values and internal ranges are included. For example the amount of polyester polyol used in the polyol component can be from 55 to 65 wt. % based on the weight of the polyol component.

The polyol component can comprise an epoxy resin. The epoxy resin can comprise from 14 to 30 dry wt. % based on the weight of the polyol component. All individual values and internal ranges are included and disclosed. For example the epoxy resin can comprise from 20 to 25 dry wt. % based on the weight of the polyol component.

The polyol component can comprise a phosphate ester polyol with the structure shown in structure 2 where R′ is selected from any organic group:

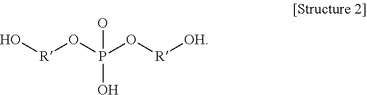

In addition to the pendant groups shown in Structure (2), R¹ may or may not have one or more additional pendant —OH groups, and R¹ may or may not have one or more additional pendant groups of Structure (2). Any two or more of the —OH groups and the group(s) of Structure (2) may or may not be attached to the same atom of R¹. Each —OH group and each group of Structure (2) can be attached to a separate atom of R¹.

A convenient way to characterize R¹ is to describe the compound having the following Structure (3):

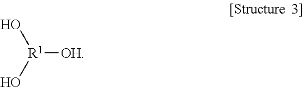

where R¹ is the same as in Structure (2). The compound having Structure (3) is referred to herein as a “precursor polyol.”

Suitable precursor polyols can have number average Mw of 90 g/mol or higher, 200 g/mol or higher, or 400 g/mol or higher. Suitable precursor polyols can have number average Mw of 4,000 g/mol or lower, 2,000 g/mol or lower, 1,200 g/mol or lower, 900 g/mol or lower, or 500 g/mol or lower. Suitable precursor polyols can have number average Mw from 200 g/mol to 4,000 g/mole, from 400 g/mol to 2,000 g/mol, from 400 g/mol to 1,200 g/mol, or from 400 g/mol to 900 g/mol.

Suitable precursor polyols can be alkyl higher polyols, monosaccharides, disaccharides, and compounds having the following Structure (4):

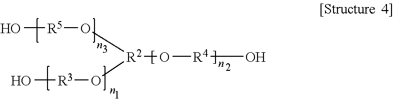

where each of R², R³, R⁴, and R⁵ is, independent of the other, any organic group; each of n₁, n₂, and n₃ is, independent of the other, an integer from 0 to 10. In addition to the pendant groups shown in Structure (4), R² may or may not have one or more additional pendant groups. It is further understood that any two or more of the pendant groups may or may not be attached to the same atom of R². In some embodiments, a mixture of compounds having Structure (4) is present, where the compounds of Structure (4) differ from each other in the value of one or more of n₁, n₂, and n₃. Such mixtures are described herein by stating a non-integer value for the parameter n₁, n₂, or n₃, where the non-integer value represents the number average of that parameter. When it is desired to assess the molecular weight of such a mixture, the number-average molecular weight is used.

Among precursor polyols having Structure (4), each pendant group can be attached to a separate atom of R². Among precursor polyols having Structure (4), one or more of R³, R⁴, and R⁵ can be a hydrocarbon group having 1 C to 4 Cs, 2 Cs to 3 Cs or 3 Cs. Among precursor polyols having Structure (4), one or more of R³, R⁴, or R⁵ can be an alkyl group, which may be linear or cyclic or branched or a combination thereof; one or more of R³, R⁴, or R⁵ can be a linear or branched alkyl group; and one or more of R³, R⁴, or R⁵ can be a branched alkyl group. R³, R⁴, or R⁵ can be identical to each other.

Among precursor polyols having Structure (4), one or more of n₁, n₂, and n₃ can be from 0 to 8. Among precursor polyols having Structure (4), one or more of n₁, n₂, and n₃ can be 1 or more. Among precursor polyols having Structure (4), one or more of n₁, n₂, and n₃ can be 6 or less. Among precursor polyols having Structure (4), n₁, n₂, and n₃ can be the same.

The group of precursor polyols having Structure (4) can be compounds in which each of R², R³, R⁴, and R⁵ is an alkyl group; such precursor polyols are known herein as alkoxylated alkyl triols. In a triol, when at least one of n₁, n₂, and n₃ is 1 or more and R² has the following Structure (5):

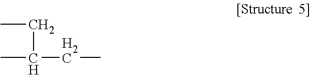

then the triol is known herein as an alkoxylated glycerol. In alkoxylated triols, when each of R³, R⁴, and R⁵ is a branched alkyl group with exactly 3 C, the alkoxylated triol is known herein as a propoxylated triol. A propoxylated triol in which R² has Structure (5) is known herein as propoxylated glycerol.

Among precursor polyols that are alkyl higher polyols, can be compounds with 10 C or fewer carbon atoms; compounds with 6 C or fewer carbon atoms; compounds with 3 or fewer carbon atoms; or glycerol.

Precursor polyols can be alkyl higher polyols and compounds having Structure (4). It is noted that, if n₁ is equal to (=) n₂=n₃=0 and if R² is either an alkyl group or an alkyl group having hydroxyl groups, then the compound having Structure (4) is an alkyl higher polyol.

The group of precursor polyols can be alkyl triols and alkoxylated alkyl triols. Among these compounds, are glycerol and alkoxylated glycerols. Among alkoxylated glycerols, are propoxylated glycerols.

The phosphate ester compound can be the reaction product of reactants including a precursor polyol and a phosphoric-type acid, where the resulting phosphate ester compound has the chemical structure of Structure (2).

The amounts of phosphoric-type acid and precursor polyol are chosen to determine the ratio of Mₚ:Mₓ as follows: M_{hy}=the number of hydroxyl groups per molecule of the precursor polyol; Nₓ=M_{hy}−2; Mₓ=(the moles of precursor polyol)×(Nₓ); and Mₚ=the moles of phosphorous atoms contained in the phosphoric-type acid.

In general, the ratio of Mₚ:Mₓ is 0.1:1 or higher, 0.2:1 or higher, 0.5:1 or higher, or 0.75:1 or higher. The ratio of Mₚ:Mₓ can be 1.1:1 or lower.

Generally, the weight ratio of phosphoric-type acid to precursor polyol is 0.005:1 or higher, 0.01:1 or higher, or 0.02:1 or higher. The weight ratio of phosphoric-type acid to precursor polyol can be 0.3:1 or lower, or 0.2:1 or lower, or 0.12:1 or lower.

The phosphoric-type acid can contain polyphosphoric acid. And, in general, the amount of polyphosphoric acid in the phosphoric-type acid is, by weight based on the weight of the phosphoric-type acid, 75 wt % or more, 80 wt % or more, or 90 wt % or more. Polyphosphoric acid is available in various grades; each grade is characterized by a percentage. To determine the grade, it is first recognized that pure monomeric orthophosphoric acid, the content of phosphorous pentoxide is considered to be 72.4%. Any grade of polyphosphoric acid can also be analyzed, to consider that one mole of polyphosphoric acid (formula weight labeled “Fppa”) contains the number of moles of phosphorous pentoxide labeled “Nppo,” and the phosphorous pentoxide percentage (“PCppo”) is given by PCppo=(Nppo×142)/Fppa, expressed as a percentage. Then, the grade of that polyphosphoric acid is the ratio, expressed as a percentage: Grade=PCppo/72.4.

The polyphosphoric acid used can have a grade of 100% or higher, or 110% or higher. The polyphosphoric acid used can have a grade of 150% or lower, or 125% or lower. Further information about suitable phosphate esters and the preparation of such suitable phosphate esters can be found, for example, in PCT Publication No. WO/2015/168670.

The phosphate ester can comprise 0.3 to 2 dry wt. % based on the weight of the solvent based laminating adhesive. All internal individual values and internal ranges are included. For example, the phosphate ester can comprise 0.5 to 1 dry wt. % based on the weight of the solvent based laminating adhesive. The phosphate ester may also be included in the isocyanate component as opposed to the polyol component.

The phosphate ester may have an NCO % of less than or equal to 14. The phosphate ester may have an NCO % from 12 to 14. All internal individual values and internal ranges are disclosed and included. For example, the phosphate ester may have an NCO % from 12.5 to 13.5.

### Adhesive Composition Formation and Use

It is contemplated that two components, an isocyanate component and a polyol component, are employed in the present disclosure. It is also contemplated that the isocyanate component and the polyol component of the disclosed adhesive composition can be made separately and, if desired, stored until it is desired to use the adhesive composition. The process of producing the adhesive composition includes mixing the isocyanate and polyol components described above to form a curable adhesive composition. In some embodiments, both the isocyanate component and the polyol component are each liquid at 25° C. When it is desired to use the adhesive composition, the isocyanate component and the polyol component are brought into contact with each other and mixed together, typically at a stoichiometric ratio (NCO/OH) between 1 and 2.5. It is contemplated that when these two components are brought into contact, a curing reaction begins in which the isocyanate groups react with the hydroxyl groups to form urethane links. The adhesive composition formed by bringing the two components into contact can be referred to as a “curable mixture.”

To form the adhesive composition, mixing of the two components may take place at any suitable time in the process of forming the adhesive composition and applying the adhesive to a substrate, such as before, during, or as a result of the application process. All of the present steps may be carried out under ambient, room temperature conditions. As desired, heating or cooling may be employed. The mixing can be carried out using a suitable conventional mixer, such as using an electrically, pneumatically, or an otherwise powered mechanical mixer.

The process for preparing the solvent-based adhesive composition of the present disclosure includes, for example, the steps of (1) providing the isocyanate component; (2) providing the polyol component; (3) mixing the two components to form a resin mixture; (4) diluting the resin mixture in a solvent to form a diluted resin mixture having an application solid content of from 25 wt % to 55 wt %, from 30 wt % to 45 wt %, or from 35 wt % to 40 wt % based on the total weight of the diluted resin mixture; and (5) removing the solvent from the composition to form the adhesive composition after the composition is applied to a substrate and before the composition is cured.

A process of forming a laminate using the adhesive composition of the present disclosure is also disclosed herein. The adhesive composition, such as the adhesive composition discussed above, can be in a liquid state at 25° C. Even if the composition is solid at 25° C., it is acceptable to heat the composition as necessary to transform the composition into a liquid state. Solvent is added to the mixed adhesive composition until the desired solids content is reached. A solids content of 25% or greater can be used.

The adhesive composition of the present disclosure is useful for bonding substrates together; and the adhesive composition can be used on a wide variety of a single suitable substrate or a plurality of suitable substrates. The substrates may be similar materials or dissimilar materials. For example, the substrate may be selected from high, low or medium density plastics (e.g., of a type selected from polystyrene, polyethylene, ABS, polyurethane, polyethylene terephthalate, polybutylene terephthalate, polypropylene, polyphenylene, polycarbonate, polyacrylate, polyvinyl chloride, polysulfone, and mixtures thereof), paper, wood and reconstituted wood products, polymer coated substrates, wax coated paperboard, cardboard, particle board, textiles, leather, and metal (e.g., aluminum, ferrous as well as other non-ferrous), metallized plastics (e.g., metallized plastic film) or the like.

Wet and dry bond lamination of a plurality of substrate layers is possible. The adhesive composition can be applied to desired substrates using conventional application techniques such as rotogravure printing, flexographic printing, conventional or airless spray, roll coating, brush coating, wire wound rod coating, knife coating, or coating processes such as curtain-, flood-, bell, disc-, and dip-coating processes. Coating a substrate with the adhesive composition may be done over the entire surface of the substrate or to a portion of the substrate's surface, such as along an edge, or at intermittent locations. Once applied to the substrate, the adhesive composition is dried, such as by application of heat and air flow, or some other suitable conventional approach for removing substantially all remaining solvent present in the adhesive composition.

A laminate comprising the solvent-based adhesive composition of the present disclosure can be formed by applying the adhesive to at least one of two different substrates and combining the substrates together such that the adhesive is disposed between the surfaces of the two substrates; and then curing the adhesive to form a bond between the two substrates. The substrates can include, for example, two separate films; and each of the films can be made of a different material or of the same material. Generally, a layer of the adhesive composition is applied to a surface of a film. The thickness of the layer of the curable adhesive composition mixture applied to a surface of a film is from 1 micron (μm) to 5 μm. As used herein, a “film” is any structure that is 0.5 mm or less in one dimension of the structure; and is 1 centimeter (cm) or more in both of the other two dimensions of the structure.

A surface of another film is brought into contact with the layer of the curable mixture to form an uncured laminate. The curable mixture is then cured or allowed to cure. The uncured laminate may be subjected to pressure, for example by passing through nip rollers, which may or may not be heated. The uncured laminate may be heated to speed the cure reaction.

Suitable substrates used to form the laminate structure include films such as paper, woven and nonwoven fabric, polymer films, metal foil, metal-coated (metallized) polymer films, and combinations thereof. The substrates are layered to form a laminate structure, with an adhesive composition according to the present disclosure adhering one or more of the substrates together. Films can optionally have a surface on which an image is printed with ink. The ink may be in contact with the adhesive composition. The films can be polymer films, metal-coated polymer films, or polymer films.

### EXAMPLES

The following examples are presented to further illustrate the present disclosure in detail but are not to be construed as limiting the scope of the claims. Unless stated to the contrary, implicit from the context, or customary in the art, all parts and percentages are based on weight and all test methods are current as of the filing date of this disclosure.

Various raw materials or ingredients used in the Inventive Examples (Inv. Ex.) and the Comparative Examples (Comp. Ex.) are explained in Table I as follows. All Commercial Samples are available from DOW Chemical.

TABLE 1
Raw Materials

| Raw Material | Description | Supplier |
|---|---|---|
| CATALYST F | Toluene diisocyanate, oligomeric reaction | Dow |
| | products with 2,2′-oxydiethanol and | |
| | propylidenetrimethanol, 75% solid content, ethyl | |
| | acetate as solvent, 12.5-13.5% NCO % | |
| SR-F1 | Phosphate Ester Containing NCO Components, | DOw |
| | 75% solid content, 12.5%-13.5% NCO % | |
| ADCOTE ™ 102A EA | Polyester solution in EAC, 36% solid content, | Dow |
| Solvent | Mₙ > 8000, with high hydrolysis backbone, | |
| Borne Adhesive | Tg = −3.6° C. | |
| ADCOTE ™ 102A | Polyester solution in MEK, 36% solid content, | Dow |
| Solvent | Mn > 8000, with high hydrolysis backbone, | |
| Borne Adhesive | Tg = −2.8° C. | |
| RESIN PE 45 M | Polyester solution in MEK, 45% solid content, | Dow |
| | Mₙ > 8000, Tg = −2.4° C. | |
| DOWSIL ™ Z-6040 | Epoxy Siliane | Dow |
| Silane | | |
| Ethyl Acetate | Solvent | SCRC |
| D.E.R. ™ 671-X75 | Epoxy | Dow |
| VYLON ™ 560 | Polyester polyol, 100% solid content, Mn > 8000, | Toyobo |
| | Tg = 7° C. | |
| VYLON ™ GK-150 | Polyester polyol, 100% solid content, Mn > 8000, | Toyobo |
| | Tg = 20° C. | |
| STABAXOL ™ P | Aromatic polycarbodiimide | Rhein |
| | | Schaefer |
| PPA 115 | 115% polyphosphoric acid | SCRC |
| ADCOTE ™ 502S | Current high performance solvent-based adhesive | Dow |
| Solvent-Borne | OH component, 51% solid content, with epoxy | |
| Adhesive | siliane as adhesion promoter, Tg = −4.7° C. | |
| ADCOTE ™ 811A | Current high performance solvent-based adhesive | Dow |
| Solvent-Borne | OH component, 60% solid content, Mn > 8000, | |
| Adhesive | with epoxy siliane as adhesion promoter, Tg < 5° C. | |
| ADCOTE ™ 545S | Current medium performance solvent-based | Dow |
| Solvent-Borne | adhesive OH component, 66.7% solid content, | |
| Adhesive | Mₙ < 8000, with epoxy siliane as adhesion | |
| | promoter, Tg < 5° C. | |
| MORFREE ™ 88-138 | Phosphate ester polyol, 100%, solid content | DOW |

TABLE 2
Two component solvent-based Laminating adhesive Formulation

| | ADCOTE ™ | ADCOTE ™ | | | | | | | |
|---|---|---|---|---|---|---|---|---|---|
| | 102A EA | 102A | | | | | | | |
| | Solvent- | Solvent- | | | | | MOR- | | |
| | Borne | Borne | RESIN | VYLON ™ | VYLON ™ | DER | FREE ™ | STABAXOL ™ | Ethyl |
| | Adhesive | Adhesive | PE 45 M | 560 | GK-150 | 671 | 88-138 | P | Acetate |
| OH-01 | 63.5% | | | | | 6.99% | .173% | | 29.4% |
| OH-01-1 | 63.0% | | | | | 6.93% | .172% | .152% | 29.7% |
| OH-01-2 | 62.6% | | | | | 6.89% | .171% | .299% | 30.0% |
| OH-02 | 63.6% | | | | | 7.00% | .0868% | | 29.3% |
| OH-03 | 63.0% | | | | | 6.93% | .859% | | 29.2% |
| OH-04 | 71.9% | | | | | 3.95% | .173% | | 24.0% |
| OH-05 | 56.8% | | | | | 9.39% | .173% | | 33.7% |
| OH-06 | | 63.5% | | | | 6.98% | .173% | | 29.4% |
| OH-06-1 | | 63.0% | | | | 6.93% | .172% | .152% | 29.7% |
| OH-07 | | | 50.8% | | | 6.98% | .173% | | 42.1% |
| OH-07-1 | | | 50.4% | | | 6.93% | .172% | .152% | 42.3% |
| OH-08 | | | | 22.7% | | 6.93% | .172% | .152% | 70.0% |
| 0H-09 | | | | | 22.7% | 6.93% | .172% | .152% | 70.0% |

Notes:
the solid content of all samples in Table 2 is 30% All percentages are weight percent based on the weight of the OH component

TABLE 3
Phosphate Ester Containing NCO Component Formulaion

| | Desmodur | Mor-free | Ethyl |
|---|---|---|---|
| Formulation | 2460M | 88-138 | acetate |
| Phosphate Ester Containing | 80 | 40 | 40 |
| NCO Component | | | |

### General Method of Production of OH Components

The OH component is the solution of the high molecular weight polyester polyol, epoxy resin, polycarbodiimide and phosphate ester which are all dissolved in organic solvent as indicated in table 2. Before the raw materials are charged into a reactor, the moisture content of all the raw materials should be less than 500 parts per million (ppm). During the entire stirring process, nitrogen is used to avoid moisture contamination. The solution system is kept at room temperature for 0.5 hours with 50 RM rotation speed. Finally, the final product is charged into a well sealed steel bottle with nitrogen protection.

### Method of Production of Phosphate Ester Containing NCO Components SR-F1

Phosphate-functional isocyanate compounds of the Inventive Examples are synthesized according to the formulations listed in Table 3. Desmodur 2460M and Mor-free 88-138 are charged into a 1000 mL glass reactor and mixed carefully as the formulations shown in Table 3. After all raw materials are fed, heating is started. When the temperature of the mixture of the raw materials reaches around 60° C., the rotation speed is increased to 50 RM. Nitrogen is applied during the whole process to protect the system from moisture. When the reaction temperature reaches around 80° C. to 85° C., the cooling process is started and the reaction is kept at 80° C. to 85° C. for 2 hours. When the NCO value reaches the designed value, the reactor is cooled as soon as possible. The system is cooled down to 60° C. to 70° C., ethyl acetate is charged into the glass reactor and the rotation speed is kept at 50 RM for 20 minutes. Then the final product is charged into a well sealed steel bottle with nitrogen protection.

### Coating and Laminating Process

Before laminating, nylon (NY) film and poly-vinyl chloride (PVC) film is stored at 50° C./85 relative humidity for 5 days which imitates the film storage condition. Coating and lamination is conducted in SDC Labo-Combi 400 machine. The nip temperature is kept at 70° C. with 100 m/min speed during the whole lamination process. The Coating weight is 4-4.5 g/m2. NY/foil is laminated first. Then the laminated film NY/foil is cured at 60° C./85 relative humidity for 7 days before testing. After curing, laminated NY/foil is laminated with PVC by following the process above.

TABLE 4
Performance Results:

| | | | Bond | | | |
|---|---|---|---|---|---|---|
| | | | strength | | | |
| | | Mix | NY/Foil | Deep Draw | V0 | |
| | | ratio | N/15MM | Depth/MM | (Na2S2O3/ml) | Sample code |
| Test | Adocte 502S/Catalyst F | 100/6.8 | 7.02 | 4.25 | 1.78 | Comparative Example-1 |
| | OH-01/Catalyst F | 100/3 | 7.74 | 4.25 | 0.43 | Inventive Example-1 |
| | OH-01/Catalyst F | 100/4 | 7.2 | 4.5 | 0.52 | Inventive Example-2 |
| | OH-01/Catalyst F | 100/6 | 6.17 | 4.75 | 0.71 | Comparative Example-2 |
| | OH-02/Catalyst F | 100/3 | 6.25 | 4.25 | 0.51 | Comparative Example-3 |
| | OH-02/Catalyst F | 100/4 | 5.42 | 4.25 | 0.62 | Comparative Example-4 |
| | OH-02/Catalyst F | 100/6 | 5.02 | 4.5 | 0.79 | Comparative Example-5 |
| | OH-03/Catalyst F | 100/3 | 5.21 | 3.75 | 0.51 | Comparative Example-6 |
| | OH-03/Catalyst F | 100/6 | 4.02 | 4 | 0.72 | Comparative Example-7 |
| | OH-01-1/Catalyst F | 100/3 | 7.45 | 4.25 | 0.15 | Inventive Example-3 |
| | OH-01-2/Catalyst F | 100/3 | 7.19 | 4.5 | 0.11 | Inventive Example-4 |
| | OH-04/Catalyst F | 100/3 | 4.88 | 3.75 | 0.45 | Comparative Example-8 |
| | OH-04/Catalyst F | 100/6 | 5.78 | 4.25 | 0.79 | Comparative Example-9 |
| | OH-05/Catalyst F | 100/3 | 4.73 | 3.75 | 0.41 | Comparative Example-10 |
| | OH-05/Catalyst F | 100/6 | 5.41 | 4 | 0.72 | Comparative Example-11 |
| | OH-06/Catalyst F | 100/3 | 7.38 | 4.25 | 0.39 | Inventive Example-5 |
| | OH-06-1/Catalyst F | 100/3 | 7.04 | 4.25 | 0.14 | Inventive Example-6 |
| | OH-07/Catalyst F | 100/3 | 7.24 | 4.25 | 0.42 | Inventive Example-7 |
| | OH-07-1/Catalyst F | 100/3 | 7.13 | 4.25 | 0.16 | Inventive Example-8 |
| | OH-08/Catalyst F | 100/3 | 3.3 | 3 | 0.17 | Comparative Example-12 |
| | OH-09/Catalyst F | 100/3 | 2.8 | 3 | 0.14 | Comparative Example-13 |
| | OH-01/Experimental | 100/3 | 7.09 | 4.5 | 0.42 | Inventive Example-9 |
| | NCO Component | | | | | |
| | OH-01/Experimental | 100/6 | 5.33 | 4.25 | 0.58 | Comparative Example-14 |
| | NCO Component | | | | | |
| | Adcote 811A/Catalyst F | 100/11 | 3.3 | 3 | 2.18 | Comparative Example-15 |
| | Adcote 545S/Catalyst F | 100/11 | 2.9 | 3 | 2.06 | Comparative Example-16 |

### Methods

### T-Peel (90°) Bonding Strength (Hand Assisted T-Peel) at 120° C. Degree

After curing, the laminated films are cut into 15 mm width strips for T-peel testing in an Instron 5965 U 5974 machine with 250 mm/min crosshead speed. Three strips are tested in a warm oven at 120° C. and the average value is taken. During the testing, the tail of the strip is pulled slightly by finger to make sure the tail remained 90° degree to the peeling direction. Results are in the unit of N/15 mm.

### Deep Draw Test (DDT)

The cured laminating films are cut into 8 cm×12 cm size pieces then positioned at the platform of a SDCK-004A auto deep draw device for evaluation. The equipment is operated with specific parameters for deep draw application which adjust the air pressure to 0.5 Mpa and maintain punch speed of molds at 100 mm/min. The depth of the deep draw test is set at 5 mm for all laminates. The appearance of laminates after deep draw application are checked and the presence of bubbles, tunnels, delamination and broken substrates are noted. After punch, the laminates are heated to 100° C. in a warm oven for 1 hour, then the appearance is checked again.

### Readily Oxidizable Substance Titration V (Na2S2O3/ml)

The cured laminating films are cut into 3 cm×0.3 cm size pieces then these small pieces are placed into well sealed glass reactors with 200 ml distilled water at 70° C. for 2 hours. 20 ml extraction aqueous solution are heated to 100° C. for 3 minutes while 20 ml potassium permanganate solution (0.002 mol/L) and 1 ml sulphuric acid solution (0.1 mol/L) are added. The resulting solution is then cooled to room temperature as soon as possible. 0.1 g potassium iodide is added and the solution is allowed to stand for 5 minutes. 0.01 mol/L sodium thiosulfate aqueous solution is used for titration. 5 drops of starch solution are added as indicator. Until the mixed solution turns transparent, the consumed volume of sodium thiosulfate aqueous solution is recorded as V1. The same steps are repeated for 20 ml distilled water instead of extraction aqueous solution, the consumed volume, V1, of sodium thiosulfate aqueous solution is recorded as V2. The difference value of V1 and V2 is measured as readily oxidizable substance release V0 (Na2S2O3/ml).

What is claimed is:

1. A two component solvent-based laminating adhesive comprising:
a. an isocyanate component comprising:
i. an isocyanate monomer, a polyisocyanate, an isocyanate prepolymer, or mixtures of two or more of these
ii. ethyl acetate
b. a polyol component comprising:
i. a polyester polyol with a molecular weight greater than or equal to 8000 and a T_{g} less than 5° C.
ii. a phosphate ester polyol of the structure below where R′ is selected from any organic group: 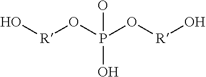
iii. epoxy resin
wherein the epoxy resin comprises 14 to 30 dry wt. % based on the weight of the polyol component; the ratio of the isocyanate component to the polyol component is 1 to 21 dry wt. % based on the weight of the solvent based laminating adhesive; and the total phosphate ester content is 0.3 to 2 dry wt. % based on the weight of the solvent based laminating adhesive.

2. The two component solvent based laminating adhesive of claim 1 wherein the phosphate ester comprises the structure below where R′ is selected from any organic group.

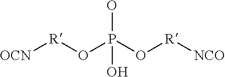

3. The two component solvent based laminating adhesive of claim 1 further comprising an additional anti-hydrolytic agent such as azopyridine or carbodiimide.

4. The two component solvent based laminating adhesive of claim 1 further comprising an antioxidant.

5. The two component solvent based laminating adhesive of claim 1 containing no siliane.

6. The two component solvent based laminating adhesive of claim 1 containing no polyether polyol.

7. The two component solvent based laminating adhesive of claim 1 containing no phenolic epoxy resin.

8. The two component solvent based laminating adhesive of claim 1 containing no highly reactive amine initiated polyol.

9. The two component solvent based laminating adhesive of claim 1 wherein the V0 measured as described in the specification is from 0.05 to 1.70 Na₂S₂O₃/ml.

10. The two component solvent based laminating adhesive of claim 1 wherein the V0 measured as described in the specification is from 0.08 to 0.20 Na₂S₂O₃/ml.

11. The two component solvent based laminating adhesive of claim 1 wherein the phosphate ester has an NCO % of less than or equal to 14.

12. The two component solvent based laminating adhesive of claim 1 wherein the phosphate ester has an NCO % from 12 to 14.

13. A laminate formed from the solvent based laminating adhesive of claim 1.
